(19) United States
(12) Patent Application Publication
(10) Pub. No.: US 2007/0182072 A1
(43) Pub. Date: Aug. 9, 2007

(54) Method of manufacturing plugged honeycomb structure and manufacturing apparatus of plugged honeycomb structure

(75) Inventors: Yukihito Ichikawa, Nagoya-city (JP); Akio Enomoto, Chita-gun (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/655,074

(22) Filed: Jan. 19, 2007

(30) Foreign Application Priority Data
Feb. 6, 2006 (JP) 2006-028263

(51) Int. Cl. C04B 33/32

(52) U.S. Cl. 264/630

(57) ABSTRACT

A method for manufacturing a plugged honeycomb structure has a process including the steps of: preparing an unplugged honeycomb structure, supplying ceramic slurry as a plugging material on an upper surface of a belt and leveling the ceramic slurry supplied on the upper surface of the belt by moving the belt to allow a blade having a straight-line side to pass in such a manner that the side of the leveling member is in parallel with the plane, and filling the plugging material into cells from openings on one side of the cells by pressing an end face on one side of the unplugged honeycomb structure against the leveled ceramic slurry. According to the present invention, there can easily be manufactured a plugged honeycomb structure having even depth of plugging members which plug open ends of cells.

### BACKGROUND OF THE INVENTION AND RELATED ART STATEMENT

The present invention relates to a method for manufacturing a plugged honeycomb structure capable of easily manufacturing a plugged honeycomb structure having a uniform depth of plugging members plugging open ends of cells and a device for manufacturing plugged honeycomb structure capable of effectively manufacturing such a plugged honeycomb structure.

There has been employed a ceramic plugged honeycomb structure excellent in thermal resistance and corrosion resistance as a carrier for a catalyst device or a filter used for environmental measures and recovery of specific substances. Particularly, the plugged honeycomb structure is recently in high demand as a diesel particulate filter (DPF) for trapping particulate matter (PM) discharged from a diesel engine.

As shown in FIG. 9, a plugged honeycomb structure 21 is provided with plugging members 26 for plugging open ends on one side of predetermined cells 24 and plugging the other open ends of the residual cells 24 in a cylindrical honeycomb structure 23 having porous partition walls 22 separating and forming a plurality of cells 24 functioning as fluid passages. In the plugged honeycomb structure 21, the plugging members 26 are alternately plugging open ends of the cells 24 in the end face B on the fluid inlet side and in the end face C on the fluid outlet side of the plugged honeycomb structure 21. For example, when a plugged honeycomb structure 21 is used as a DPF to introduce target gas G1 to be treated into cells 24 from the end face B on the inlet side, dust and particulate matter are trapped by the partition walls 22, and treated gas G2 passing through the porous partition walls 22 and flowing into adjacent cells 24 is separated from the dust and particulate matter in the target gas G1 and discharged from the end face C on the outlet side.

The plugged honeycomb structure 21 as described above can be manufactured by preparing a cylindrical unfired honeycomb structure having porous partition walls separating and forming a plurality of cells functioning as fluid passages by extrusion forming, and then subjecting the honeycomb structure to the following plugging process. In the plugging process, in the first place, a mask is pasted on one end face of the unfired honeycomb structure. The mask is pasted by sticking an adhesive sheet on one end face of an unfired honeycomb structure, followed by making holes in portions corresponding to cells to be plugged of the adhesive sheet by laser processing using an image processing. Then, the one end face where the mask is pasted of the unfired honeycomb structure is immersed in a plugging material (ceramic slurry) stored in a container to fill the plugging material into the cells to be plugged. The plugging material is filled in the cells to be plugged on the other end face of the unfired honeycomb structure in the same manner. The unfired honeycomb structure having the plugging material filled therein is dried and fired to obtain the plugged honeycomb structure 21. Incidentally, regarding the plugged honeycomb structure, for example, JP-A-2001-300922 can be referred to.

### SUMMARY OF THE INVENTION

However, in the case of manufacturing such a plugged honeycomb structure though the above plugging process, there arises a problem of easily having uneven depth of the plugging members. The “depth of the plugging members” means length of the plugging members in the axial direction of the plugged honeycomb structure. It is noted, as one of the reasons why such a problem is caused, that it is difficult to level ceramic slurry as a plugging material in a container. In addition, even if ceramic slurry as a plugging material is leveled, when a honeycomb structure is immersed in the ceramic slurry stored in a container, ceramic slurry moves toward the outer periphery side of the honeycomb structure (In other wards, as the honeycomb structure is put in the slurry under pressure, slurry between the end face of the honeycomb structure and the bottom of the container is pressed against the end face of the honeycomb structure and moves outside the structure.), and this tends to make the depth of the plugging members on the outer periphery side of the honeycomb structure shallow. If the plugging members have a variance in depth, since a filtration area is reduced in the portion having a deep plugging member in the case that the honeycomb structure is used as a DPF, pressure loss increases there when the same amount of target gas is sent in the honeycomb structure.

The present invention has been made in view of such conventional circumstances and aims to provide a means capable of easily manufacturing a plugged honeycomb structure having even depth of plugging members plugging open ends of the cells. As a result of repeated study, it has been found that the above problem can be solved by the following means where leveling of the plugging material in a container is not required.

That is, according to the present invention, there is provided a method for manufacturing a plugged honeycomb structure provided with a cylindrical honeycomb structure having a plurality of cells functioning as fluid passages and partitioned by porous partition walls and plugging members for plugging open ends on one side of the cells, wherein the method has a process of forming the plugging members on open ends on one side of the cells, the process comprising the steps of: preparing an unplugged honeycomb structure, supplying a plugging material on a plane and leveling the plugging material on the plane by moving a leveling member having a straight-line side or by moving the plane to allow the leveling member to pass in such a manner that a side of the leveling member is in parallel with the plane, filling the plugging material into cells from openings on one side of the cells by pressing an end face of the unplugged honeycomb structure against the leveled plugging material on the plane or by pressing the leveled plugging material against the end face of the unplugged honeycomb structure on the plane (sometimes referred to as the first manufacturing method of a plugged honeycomb structure of the present invention or simply as the first manufacturing method of the present invention).

According to the present invention, there is also provided a method for manufacturing a plugged honeycomb structure provided with a cylindrical honeycomb structure having a plurality of cells functioning as fluid passages and partitioned by porous partition walls and plugging members for plugging open ends on one side of the cells, wherein the method has a process of forming the plugging members on open ends on one side of the cells, the process comprising the steps of: preparing an unplugged honeycomb structure, disposing a plugging material supplier having a slit aperture one a plane in parallel with the plane and supplying a plugging material on a plane from the slit aperture of the plugging material supplier with moving the plugging material supplier or with moving the plane to level the plugging material on the plane, and filling the plugging material into the cells from openings on one side of the cells by pressing an end face of the unplugged honeycomb structure against the leveled plugging material on the plane or by pressing the leveled plugging material against the end face of the unplugged honeycomb structure on the plane (sometimes referred to as the second manufacturing method of a plugged honeycomb structure of the present invention or simply as the second manufacturing method of the present invention).

“Methods for manufacturing a plugged honeycomb structure of the present inventions” means both the first manufacturing method and the second manufacturing method. In methods for manufacturing a plugged honeycomb structure of the present invention, both the first manufacturing method and the second manufacturing method are methods for manufacturing a plugged honeycomb structure provided with a honeycomb structure and plugging members for plugging open ends on one side of the cells, in other wards, a method for manufacturing a plugged honeycomb structure where open ends on one side of cells of the honeycomb structure are plugged with plugging members and a manufacturing method characterized by a plugging process where a honeycomb structure is subjected to plugging. In addition, an object of plugging may be an unfired honeycomb structure (dried body) or a fired honeycomb structure. That is, the plugging process of a manufacturing method of a plugged honeycomb structure of the present invention may be performed before firing the honeycomb structure as an object of plugging, or the plugging process may be performed after firing, followed by re-firing. If the plugging material is left green without re-firing, sometimes strength or thermal resistance is not exhibited. A plugging material constituted by a cordierite raw material does not exhibit characteristics as cordierite without firing. Therefore, it is preferable to re-fire the plugging material.

A method for manufacturing a plugged honeycomb structure of the present invention does not require a step of pasting a mask to cells to be unplugged with respect to a honeycomb structure as an object of plugging. However, in the case that cells to be plugged are limited in a plugging process, a mask is pasted to the cells to be unplugged with respect to a honeycomb structure as an object of plugging after an unplugged honeycomb structure is obtained and before a plugging process is performed. In this case, a method for manufacturing a plugged honeycomb structure of the present invention does not limit a masking means.

In a method for manufacturing a plugged honeycomb structure of the present invention, the expression of “a plugging material is filled into cells from openings on one side to form plugging members at open ends on one side of the cells” means that the plugging material forms plugging members at open ends on one side of the cells by subjecting the plugging material (the whole honeycomb structure including the plugging material) to drying and firing. A method for manufacturing a plugged honeycomb structure of the present invention does not limit concrete conditions for drying or firing the whole honeycomb structure including the plugging material.

In a method for manufacturing a plugged honeycomb structure of the present invention, it is preferable that vibrations are applied to the plugging material when the plugging material is supplied on the plane.

In other words, it is preferable that a plugging material is supplied on the plane with applying vibrations to the plugging material. The frequency of the vibrations is preferably 20 to 800 Hz, more preferably 200 to 250 Hz.

In a method for manufacturing a plugged honeycomb structure of the present invention, it is preferable that vibrations are applied to the plugging material leveled on the plane when the plugging material is filled into the cells from the openings on one side of the cells.

In other words, it is preferable that an end face of an unplugged honeycomb structure is pressed against a plugging material leveled on a plane or pressing a plugging material leveled on a plane against an end face of an unplugged honeycomb structure with applying vibrations to the plugging material leveled on the plane to fill the plugging material into cells from openings on one side of the cells. The frequency of the vibrations is preferably 20 to 800 Hz, more preferably 200 to 250 Hz.

In a method for manufacturing a plugged honeycomb structure of the present invention, it is preferable that at the time of filling a plugging material into cells from an end of opening an outer periphery on an end face side of the unplugged honeycomb structure is covered with a cylindrical jig so that the end face of the unplugged honeycomb structure is surrounded by the cylindrical jig.

In the case of using a cylindrical jig as described above, it is preferable that a tip end of the cylindrical jig is allowed to protrude from an end face of the honeycomb structure in advance to press the end face of the unplugged honeycomb structure against the plugging material leveled on a plane or to press the plugging material leveled on a plane against the end face of the unplugged honeycomb structure with allowing the cylindrical jig to slide (with putting back the cylindrical jig) in so that the tip end of the cylindrical jig may meet an end face of the honeycomb structure.

In a method for manufacturing a plugged honeycomb structure of the present invention, it is preferable that the plane is horizontal when the plugging material is leveled and that the plane is vertical when the end face of the unplugged honeycomb structure is pressed against the leveled plugging material or when the leveled plugging material is pressed against the end face of the unplugged honeycomb structure. In this case, it is preferable that the cylindrical unplugged honeycomb structure is maintained in such a matter that the end faces face horizontal directions, the plugging material is leveled on the (vertical) planes on both the end face sides of the (maintained) honeycomb structure, pressing the plugging material leveled on the planes against both the end faces of the unplugged honeycomb structure at the same time.

The expression of “(the honeycomb structure) is maintained in such a matter that the end faces of the honeycomb structure face horizontal directions” means to maintain the honeycomb structure in such a manner that the axial direction of the cylindrical honeycomb structure coincides with the horizontal direction. Since the directions the end portions face are horizontal directions, it is the same as the state where the honeycomb structure is laid. On the other hand, in the state that the end faces of the honeycomb structure face vertical directions, the directions the end faces face are the vertical directions. Therefore, it is in the state that the honeycomb structure is stood, and the axial directions of the cylindrical honeycomb structure are the same as the vertical directions.

In a method for manufacturing a plugged honeycomb structure of the present invention, it is preferable that the plugging material is of ceramic slurry containing a pore former. Though the pore former is not particularly limited, examples of the pore former include foaming resin, graphite, flour, starch, phenol resin, poly(methyl methacrylate), polyethylene, polyethylene telephthalate, shirasu balloon, and fly ash balloon.

In a method for manufacturing a plugged honeycomb structure of the present invention, it is preferable that the ceramic slurry has a viscosity of 50 to 1500 dPa·s. More preferably, the ceramic slurry has a viscosity of 100 to 1000 dPa·s, and particularly preferably, it is 200 to 1000 dPa·s. When the viscosity is too low, it is difficult to keep the plugging material filled into the cells. When the viscosity is too high, filling of the plugging material into the cells is difficult. Since the ease in keeping or filling the plugging material depends on the size of a cross section of a cell and the depth to be plugged, suitable viscosity should be selected appropriately according to the design specification of these.

Next, according to the present invention, there is provided a device for manufacturing a plugged honeycomb structure by plugging open ends on one side of a plurality of cells functioning as fluid passages and partitioned by porous partition walls of a cylindrical honeycomb structure with plugging members, the device comprising: a belt conveyer provided with a portion where a belt having a plane horizontally moves and a portion where the belt vertically moves, a plugging material supplier for supplying a plugging material to function as the plugging member or the plane of the belt, a leveling means for leveling the plugging material supplied on the plane on a portion where the belt horizontally moves, a honeycomb structure fixing means for disposing and fixing a honeycomb structure in such a manner that one end face on one side where open ends of the cells of the cylindrical honeycomb structure are shown faces the plane of the belt in a portion where the belt vertically moves, and a pressing means for pressing the leveled plugging member in a portion where the belt vertically moves from the side opposite to the plane of the belt where the plugging material is supplied to fill the plugging material into the cells on the end face on one side of the fixed honeycomb structure.

In a device for manufacturing a plugged honeycomb structure of the present invention, the four means shown in the methods for manufacturing a plugged honeycomb structure of the present invention can be given as the leveling means for leveling a plugging material. That is, the four means are (1) a means where, with supplying a plugging material on a plane, a leveling member having a straight-line side is moved in such a manner that the straight-line side is in parallel with the plane, (2) a means where with supplying a plugging material on a plane and using a leveling member having a straight-line side, the leveling member is allowed to pass with moving the plane in such a manner that the straight-line side of the leveling member is in parallel with the plane, (3) a means where a plugging material supplier having a slit aperture is disposed on a plane in parallel with the plane and where a plugging material is supplied on a plane from the slit aperture of the plugging material supplier with moving the plugging material supplier, and (4) a means where a plugging material supplier having a slit aperture is disposed on a plane in parallel with the plane and where a plugging material is supplied on a plane from the slit aperture of the plugging material supplier with moving the plane. (1) and (2) are the leveling means in the first manufacturing method of the present invention, while (3) and (4) are the leveling means in the second manufacturing method of the present invention. As particularly preferable belt conveyers, a stainless belt conveyer and a steel (including stainless steel) belt conveyer are given.

In a device for manufacturing a plugged honeycomb structure of the present invention, it is preferable that the device has a vibration applying means for applying vibrations to the plugging material supplied on a plane of a portion where the belt of the belt conveyer vertically moves.

As a vibration applying means provided in a portion where the belt of the belt conveyer vertically moves, any means may be employed as long as it can apply vibrations to the belt of the belt conveyer. This is because vibrations can be applied on the plugging material supplied on the belt by means of the belt. As an example of the means, a means having a turbine type vibrator as a vibration source is given. To be concrete, a means having a vibrator mounted on a press table supported by means of an elastic member such as a spring and disposed in contact with the belt can be given as a means for applying vibrations.

In a device for manufacturing a plugged honeycomb structure of the present invention, it is preferable that the plugging material supplier is provided with a vibration applying means for applying vibrations to the plugging material.

The vibration applying means provided in the plugging material supplier is for applying vibrations to the plugging material before it is supplied on a plane of the belt. As an example of the vibration applying means, a turbine type vibrator which can directly be mounted to the plugging material supplier can be given.

As a basic mode of a device for manufacturing a plugged honeycomb structure of the present invention, the device is provided with one set of the above belt conveyer, the above plugging material supplier, the above leveling means, the above honeycomb structure fixing means, and the above pressing means. However, in a device for manufacturing a plugged honeycomb structure of the present invention, it is preferable that the plugging material can be filled into the cells at the same time from both the one end face side and the other end face side of the fixed honeycomb structure by providing the device with a second set of the belt conveyer, the plugging material supplier, the leveling means, and the pressing means, disposing the belt conveyer of the second set in such a manner that the other end face where open ends of cells of the fixed cylindrical honeycomb structure faces a plane of the belt on a portion where the belt of the belt conveyer of the second set vertically moves, and pressing the plugging material supplied by the plugging material supplier of the second set on a plane of the belt of the belt conveyer of the second set and leveled by the leveling means of the second set in a portion where the belt of the belt conveyer of the second set vertically moves from the side opposite to the plane of the belt where the plugging material is supplied by the pressing means of the second set simultaneously with an original pressing means.

In addition, in a device for manufacturing a plugged honeycomb structure of the present invention, it is preferable that the belt of the belt conveyer has a loop system (regardless of the number of belt conveyer(s) and the like). “a loop system” means a mode where a plane of the belt is successively formed in cycles and where the belt moves from the portion of horizontal movement to the portion of vertical movement and returns to the portion of horizontal movement in time.

In the first manufacturing method of the present invention, since a plugging material is supplied on a plane and the plugging material on the plane is leveled by moving the leveling member having a straight-line side or by moving the plane to allow the leveling member to pass in such a manner that a side of the leveling member is in parallel with the plane, it is not necessary to level the plugging material in a container, and thickness of the plugging material on the plane can be made uniform. In addition, by positioning the leveled member on a plane and adjusting a gap between the leveled plugging member and the plane, thickness of the plugging material on the plane can easily be adjusted, and depth of the plugging member can simply be adjusted.

In the second method of the present invention, since a plugging material supplier having a slit aperture is disposed on a plane in parallel with the plane and supplying a plugging material on the plane with moving the plugging material supplier or with moving the plane to supply the plugging member on the plane from the slit aperture of the plugging material supplier to level the plugging material on the plane, it is not necessary to level the plugging material in a container, and thickness of the plugging material on the plane can be made uniform. In addition, by adjusting width of the slit aperture of the plugging material supplier, thickness of the plugging material on the plane can easily be adjusted, and depth of the plugging member can simply be adjusted.

Since, in a conventional manufacturing method (plugging process), a plugging material (ceramic slurry) was stored in a container to fill the plugging material into the cells, the plugging material remains in the container after the filling, and time and effort were spent on washing of the container. However, since it is not necessary to level the plugging material in a container in the method for manufacturing a plugged honeycomb structure of the present invention (the first manufacturing method and the second manufacturing method), time and effort spent on washing of the container can be saved. In addition, by constituting a plane where the plugging material is supplied by the belt of the belt conveyer, recycling of the plugging material becomes easy, and it is possible to attempt to reduce an amount of the plugging material practically used and consumed.

Since the plugging material is of ceramic slurry containing a pore former in a preferable mode in a method for manufacturing a plugged honeycomb structure of the present invention, a shrunk dent (a defect of forming a depression on an end face of a plugging member) is inhibited from being caused, and the plugging member can easily be leveled. This is because, when a pore former is added to ceramic slurry, water contained in the ceramic slurry is inhibited from moving freely by the pore former and hardly absorbed by the honeycomb structure, and this suppresses a phenomenon of decreasing volume of the ceramic slurry to be the plugging members because water contained in the slurry is abruptly absorbed by the honeycomb structure. This effect can be obtained in good conditions in the case that the pore former is a foaming resin. In addition, since the plugging member becomes porous, a pressure loss of the plugged honeycomb structure is further reduced.

In the case that the plugging material is of ceramic slurry containing a pore former, since the ceramic slurry has high viscosity, the plugging material hardly moves on the outer periphery side of the honeycomb structure, and variance in depth of plugging can be inhibited. In addition, by employing ceramic slurry (plugging material) having high viscosity, a plugging process can be conducted in a state that the plane is made vertical or upside down. Further, since the ceramic slurry has a high viscosity of particularly preferably 200 dPa·s or more, a shrink dent is more hardly caused when the ceramic slurry is dried. Incidentally, when the viscosity is below 50 dPa·s, it is apprehended that the plugging material is hardly kept in the cell passages. When the viscosity is below 100 dPa·s, it is apprehended that a shrink dent is easily caused in the plugging member. Therefore, the viscosity is preferably 50 dPa·s or more, and more preferably 100 dPa·s or more. In addition, the viscosity is preferably 1500 dPa·s or less because, when the viscosity is above 1500 dPa·s, it is sometimes difficult to fill the plugging material into the cells depending on the cell structure or depth of plugging.

As described above, since depth of the plugging member can be made uniform according to a method for manufacturing a plugged honeycomb structure of the present invention, the problem of partial rise in pressure loss does not arise because a filtration area is uniform in each cell in the case that the resultant plugged honeycomb structure is used as a DPF, for example.

In a preferable mode of a method for manufacturing a plugged honeycomb structure of the present invention, a plane upon leveling the plugging material is horizontal, and a plane when an end face of the unplugged honeycomb structure is pressed against the leveled plugging material or when the leveled plugging material is pressed against an end face of the unplugged honeycomb structure is vertical. In such a mode, by keeping the end faces of the unplugged cylindrical honeycomb structure to face the horizontal directions, the leveled plugging material can easily be pressed against both the end faces of the honeycomb structure at the same time. That is, the honeycomb structure is transported in the state that it is laid (state that the end faces of the honeycomb structure face horizontal directions), and it is possible to fill the plugging material into the cells under pressure in both the end faces at the same time. In addition, it can be treated with only one time of drying. Therefore, one step is sufficient instead of conventional two steps, which is efficient. In addition, since only one drying step is required, energy can be saved. Further, equipment for realizing such a successive production method (a device for manufacturing a plugged honeycomb structure of the present invention) is simple. In a conventional method where a plugging material is filled into the cells under pressure in a state that the honeycomb structure is stood (state that the end faces of the honeycomb structure faces vertical directions), two filling steps are required because filling of the plugging material in cells of each end face of the honeycomb structure is conducted independently, and moreover each time of filling requires drying. Therefore, it needs a long production process, and more energy is spent on drying. According to a method for manufacturing a plugged honeycomb structure of the present invention, such problems can be solved.

A device for manufacturing a plugged honeycomb structure of the present invention is a device suitable for carrying out a method for manufacturing a plugged honeycomb structure of the present invention, and the aforementioned effect can be obtained by carrying out a method for manufacturing a plugged honeycomb structure of the present invention with using a device for manufacturing a plugged honeycomb structure of the present invention.

### BRIEF DESCRIPTION OF THE DRAWINGS

FIG. 1 is a perspective view showing an example of a plugged honeycomb structure manufactured by a method for manufacturing a plugged honeycomb structure of the present invention.

FIG. 2 is a cross-sectional view showing an example of a cross-section taken along a plane containing the central axis of the plugged honeycomb structure shown in FIG. 1.

FIG. 3 is a perspective view showing an unfired honeycomb structure in an embodiment of a method for manufacturing a plugged honeycomb structure of the present invention.

FIG. 4 is a view showing an embodiment of the first manufacturing method of a plugged honeycomb structure of the present invention and a view expressing a plugging process.

FIG. 5 is a view showing an embodiment of the second manufacturing method of a plugged honeycomb structure of the present invention and a view expressing a plugging process.

FIG. 6 is a cross-sectional view showing a honeycomb structure with a mask pasted thereon in an embodiment of a method for manufacturing a plugged honeycomb structure of the present invention.

FIG. 7 is a view showing another embodiment of the first manufacturing method of a plugged honeycomb structure of the present invention and a view expressing a plugging process.

FIG. 8 is a view showing still another embodiment of the first manufacturing method of a plugged honeycomb structure of the present invention and a view expressing a plugging process.

FIG. 9 is a cross-sectional view showing a structure of a conventional plugged honeycomb structure.

FIG. 10 is a view showing another embodiment of the second manufacturing method of a plugged honeycomb structure of the present invention and a view expressing a plugging process.

FIG. 11 is a view showing still another embodiment of the second manufacturing method of a plugged honeycomb structure of the present invention and a view expressing a plugging process.

FIG. 12 is a view showing still another embodiment of the first manufacturing method of a plugged honeycomb structure of the present invention and a view expressing a plugging process.

FIG. 13 is a view showing still another embodiment of the first manufacturing method of a plugged honeycomb structure of the present invention and a view expressing a plugging process.

FIG. 14 is a perspective view expressing a state of covering an end face of an unplugged honeycomb structure with a cylindrical jig in an embodiment of a method for manufacturing a plugged honeycomb structure of the present invention.

### DESCRIPTION OF REFERENCE NUMERALS

1: plugged honeycomb structure, 2: honeycomb structure, 3: plugging member, 4: partition wall, 5: cell, 5a: predetermined cell, 5b: remaining cell, 6a: one open end, 6b: the other open end, 7a: one end face, 7b: the other end face, 12: unfired honeycomb structure, 13: ceramic slurry, 14: partition wall, 15: cell, 15a: predetermined cell, 15b: remaining cell, 16a: one open end, 16b: the other open end, 17a: one end face, 17b: the other end face, 19: mask, 21: plugged honeycomb structure, 22: partition wall, 23: honeycomb structure, 24: cell, 26: plugging member, G1: target gas to be treated, G2: treated gas

### DESCRIPTION OF PREFERRED EMBODIMENTS

Embodiments of the present invention are described with referring to drawings. However, the present invention is by no means limited to these embodiments. Various kinds of changes, modifications, improvements, and substitutions may be added on the basis of those skilled in the art within the range of not spoiling the gist of the present invention. For example, though the drawings show preferable embodiments of the present invention, the present invention is not limited to the modes shown by the drawings or not restricted by the information shown by the drawings. When the present invention is carried out or verified, a means which is the same as or equivalent to the means described in the present specification can be applied, a suitable means is the means described below.

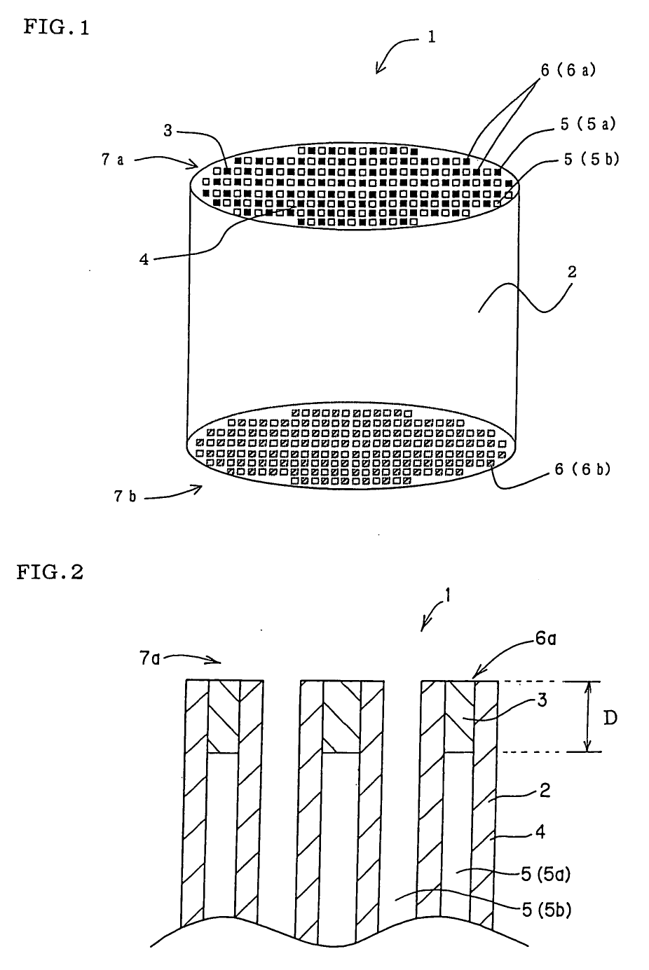

First, the first manufacturing method of a plugged honeycomb structure of the present invention will be described. FIG. 1 is a perspective view schematically showing a plugged honeycomb structure to be manufactured. FIG. 2 is a view (cross-sectional view) showing an example of a cross-section taken along a plane containing the central axis of the plugged honeycomb structure shown in FIG. 1. The plugged honeycomb structure 1 shown in FIG. 1 is a cylindrical honeycomb structure 2 having a honeycomb structure where a plurality of cells 5 functioning as fluid passages are separated and formed by porous partition walls 4. In the honeycomb structure 2, one open end 6a of each of the predetermined honeycomb cells 5a is plugged with a plugging member 3, and the other open end 6b of each of the remaining cells 5b is plugged with a plugging member 3. The plugged honeycomb structure 1 obtained by a method for manufacturing a plugged honeycomb structure of the present invention has flat end faces of the plugging members 3 and a depth D adjusted to be a predetermined value of the plugging members 3 in the end faces of the honeycomb structure 2 (see FIG. 2).

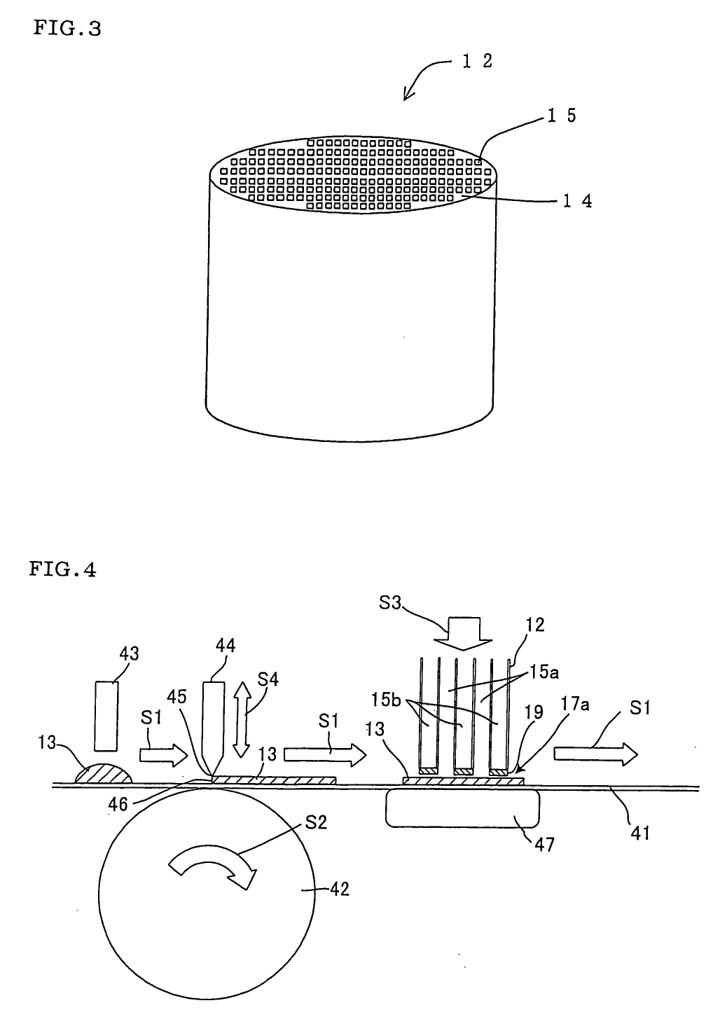

In the first manufacturing method of a plugged honeycomb structure of the present invention, an unfired honeycomb structure as shown in FIG. 3 is obtained in the first place in order to manufacture the plugged honeycomb structure 1. The unfired honeycomb structure 12 shown in FIG. 3 is a cylindrical structure having a honeycomb structure where a plurality of cells 15 functioning as fluid passages are separated and formed by porous partition walls 14. Such an unfired honeycomb structure 12 can be obtained by subjecting a forming raw material containing ceramic to extrusion forming and drying. As the forming raw material containing ceramic, there may suitably be employed a material prepared by mixing a binder, a dispersant, and the like, with a ceramic powder of cordierite, mullite, alumina, spinel, silicon carbide, silicon nitride, lithium aluminum silicate, aluminum titanate, or the like, followed by kneading. A method of extrusion forming is not particularly limited, and a conventionally known method such as extrusion forming using, for example, a vacuum extrusion forming machine can be employed.

Next, in a dried unfired honeycomb structure 12, a mask is applied on cells which do not require plugging as shown in FIG. 6. To be concrete, a mask 19 covering open ends of the (remaining) cells 15b other than the predetermined cells 15a is disposed on one end face 17a of the unfired honeycomb structure 12. The mask 19 is for introducing ceramic slurry into only the predetermined cells 15a, and a conventional masking means can suitably be employed. For example, the mask 19 can be formed by pasting an adhesive sheet on one end face 17a of the unfired honeycomb structure 12 and then making holes in the predetermined portions corresponding with the predetermined cells 15a.

Next, a plugging process for filling the plugging material in cells is conducted. FIG. 4 is a view showing a plugging process and a view showing a state of filling the plugging material into the cells 15a of the unfired honeycomb structure 12 with seeing through the unfired honeycomb structure 12 from a side (side where a peripheral face can be seen) of the unfired honeycomb structure 12. For easy understanding, the number of cells of the unfired honeycomb structure 12 is reduced in FIG. 4.

In the embodiment shown in FIG. 4, a belt conveyer where a metallic belt 41 made of, for example, stainless, steel, or the like moves toward the arrow S1 direction by the rotation of the roller 42 in the arrow S2 direction is used. The upper surface of the belt 41 of the belt conveyer is constituted as a plane where ceramic slurry 13 functioning as the plugging material is supplied. The unfired honeycomb structure 12 where plugging is applied is disposed in a position facing the press table 47 via the belt 41.

The ceramic slurry 13 functioning as the plugging material is supplied on the upper surface (plane) of the belt 41 from the nozzle 43 (of the plugging material supplier the whole of which is not illustrated) and leveled with a leveling member. The amount of the ceramic slurry 13 supplied on the upper surface of the belt 41 from the nozzle 43 is larger than the amount required for filling into the cells 15a. The ceramic slurry 13 is leveled by using a blade 44 having a straight-line side 45 as the leveling member, and moving the belt 41 so that the side 45 is in parallel with the upper surface (plane) of the belt 41 to allow the belt 41 to pass the fixed blade 44, to be more strict, by passing the belt 41 through the slit-shaped space 46 formed between the roller 42 and the blade 44. Thickness of the ceramic slurry 13 can be changed by adjusting the height of the space 46 by moving the blade 44 in the arrow S4 direction. Depending on the thickness of the ceramic slurry 13, the depth D of the resultant plugging members 3 (see FIG. 2) can be determined (although the depth is changed more or less by firing).

After the ceramic slurry 13 is leveled on the belt 41, when the leveled ceramic slurry 13 is located at the press table 47, movement of the best 41 is once stopped, and an unplugged unfired honeycomb structure 12 is pressed in an arrow S3 direction with holding the honeycomb structure 12, for example, with an outer diameter chuck which is a part of a honeycomb structure conveying means in such a manner that an end portion of the unfired honeycomb structure 12 is pressed against the leveled ceramic slurry 13 to fill the ceramic slurry 13 into the cells 15a from the openings on one side of the cells 15a of the unfired honeycomb structure 12. The ceramic slurry 13 filled in the cells 15a is dried and fired to form plugging members 3.

In the above plugging process, upon leveling the ceramic slurry 13, the blade 44 is fixed, and the belt 41 is moved. However, the blade 44 may be moved in such a manner that a side 45 is in parallel with the upper surface (plane) of the belt 41 with stopping the belt 41, or the blade 44 may be moved with moving the belt 41.

In addition, in the above plugging process, upon filling the ceramic slurry 13 into the cells 15a from openings on one side of the cells 15a, unplugged unfired honeycomb structure 12 is pressed in such a manner that an end face of the unfired honeycomb structure 12 is pressed against the leveled ceramic slurry 13. However, the press table 47 may be pressed from the bottom side to the top side of FIG. 4 so that the leveled ceramic slurry 13 on the belt 41 is pressed against an end face of the unplugged unfired honeycomb structure 12 with keeping an unplugged unfired honeycomb structure 12 stationary. Alternatively, the press table 47 may be pressed from the bottom side to the top side of FIG. 4 with pressing the unplugged unfired honeycomb structure 12 to press the leveled ceramic slurry 13 on the belt 41 against an end face of the unplugged unfired honeycomb structure 12.

There is no particular limitation on a plugging material (ceramic slurry) used for a method for manufacturing a plugged honeycomb structure of the present invention, and, for example, a material prepared by adding a binder, a dispersant, and the like, to a cordierite powder and kneading them can suitably be employed. There is no particular limitation on kind of the ceramic powder, and a powder similar to the ceramic powder contained in a forming raw material for extrusion forming of the aforementioned unfired honeycomb structure 12 or a different powder may be employed. Incidentally, the ceramic slurry 13 remaining on the upper surface of the belt 41 without being used can easily be removed from the belt 41, and removed ceramic slurry 13 can be recycled as a plugging material.

After the plugging process on one end face 17a side is completed, the ceramic slurry 13 is dried. By the drying, the ceramic slurry 13 is hardened to a degree of not deforming the shape in the following drying and firing steps. There is no particular limitation on a means for drying the ceramic slurry 13, and there may be employed a method in which drying is performed with the unfired honeycomb structure 12 where a plugging material is filled being mounted on a hot plate in the state that one end face 17a side of the structure faces downward, hot air drying where drying is performed with hot air blowing the ceramic slurry 13, or microwave drying.

Next, in the other end face of the unfired honeycomb structure 12, ceramic slurry is filled into open ends on the other side of the remaining cells 15b in the same manner. The following drying and firing gives a plugged honeycomb structure 1. A firing means is not particularly limited, and firing can be performed according to a conventionally known firing method and conditions. Incidentally, the mask 19 is made to burn down simultaneously with firing or removed before firing.

The plugged honeycomb structure 1 obtained as described above can be used as a catalytic device by loading a catalyst on the inner surface of the partition walls 4 and/or the pores inside the partition walls. Also, in the case that the plugged honeycomb structure 1 is used as a DPF, it is preferable to load a catalyst having a function of accelerating combustion of accumulating matter (particulate matter) trapped by the partition walls 4. Suitable examples of the catalyst include noble metals such as Pt, Pd, and Rh, and nonmetal perovskite type catalyst. As the means for loading a catalyst, a conventionally known catalyst loading method can be employed.

Next, the second manufacturing method of a plugged honeycomb structure of the present invention is described. A description will be made as employing a plugged honeycomb structure 1 shown in FIGS. 1 and 2 in the same manner as in the aforementioned first manufacturing method. The second manufacturing method is different in a plugging process where a plugging material is filled into cells from the first manufacturing method. However, the other processes can be performed by similar or known processes. In the following description of the second manufacturing method, descriptions regarding the same processes and conditions as those of the first manufacturing method are omitted.

In the second manufacturing method of a plugged honeycomb structure of the present invention, an unfired honeycomb structure (see FIG. 3) is obtained in the first place in order to produce a plugged honeycomb structure 1. Next, a mask is applied to cells to be unplugged of a dried unfired honeycomb structure 12 (see FIG. 6).

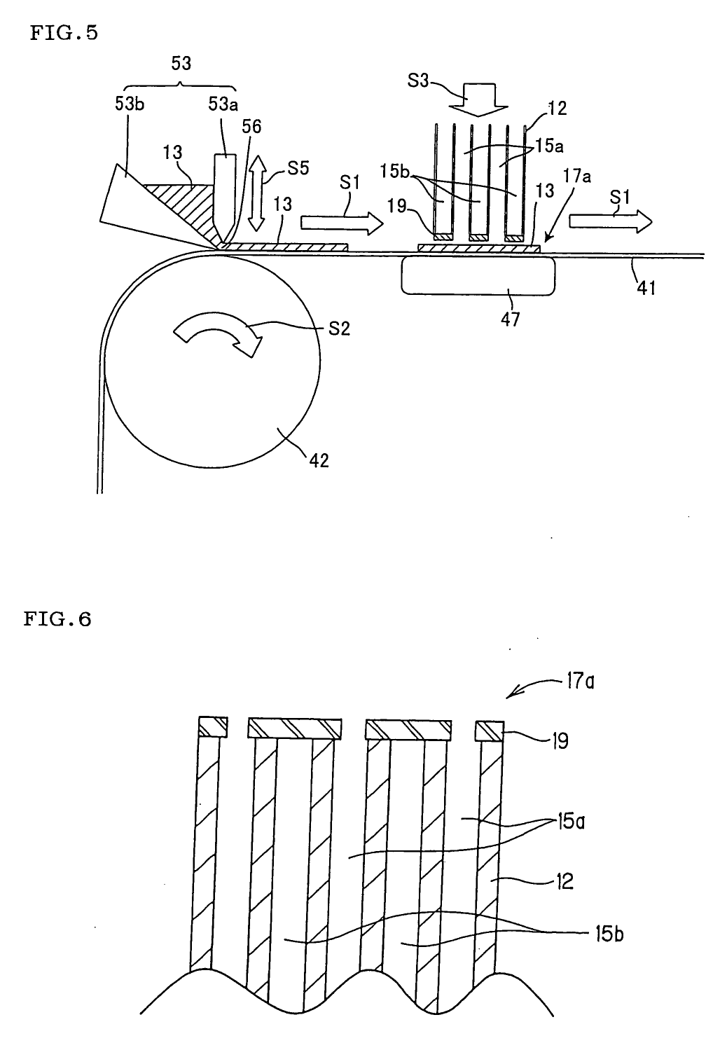

Then, a plugging process where a plugging material is filled into cells is performed. FIG. 5 is a view showing a plugging process and a view showing a state of filling the plugging material into the cells 15a of the unfired honeycomb structure 12 with seeing through the unfired honeycomb structure 12 from a side (side where a peripheral face can be seen) of the unfired honeycomb structure 12. For easy understanding, the number of cells of the unfired honeycomb structure 12 is reduced in FIG. 5.

In the embodiment shown in FIG. 5, a belt conveyer where a metallic belt 41 moves toward the arrow S1 direction by the rotation of the roller 42 in the arrow S2 direction is used. The upper surface of the belt 41 of the belt conveyer is constituted as a plane where ceramic slurry 13 functioning as the plugging material is supplied. On the upper surface of the belt 41 is fixedly disposed a plugging material supplier 53 constituted by a gate 53a and a container 53b in parallel with the surface. The plugging material supplier 53 has a slit aperture 56 capable of changing the size of the opening by the gate 53a. An unfired honeycomb structure 12 to be plugged is disposed in a position facing the press table 47 via the belt 41.

By discharging a certain amount of ceramic slurry 13 as a plugging material per hour from the slit aperture 56 of the plugging material supplier 53 on an upper surface (plane) of the belt 41 moving at a certain rate, the ceramic slurry 13 can be supplied on the upper surface of the belt 41 in a leveled state. The amount of ceramic slurry 13 discharged (supplied) on the upper surface of the belt 41 from the slit aperture 56 is larger than the amount required for filling into the cells 15a. Thickness of the ceramic slurry 13 can be changed by adjusting the height of the slit aperture 56 by moving the position of the gate 53a constituting the plugging material supplier 53 in the arrow S5 direction. Depending on the thickness of the ceramic slurry 13, the depth D of the resultant plugging members 3 (see FIG. 2) can be determined (although the depth is changed more or less by firing).

After the ceramic slurry 13 leveled on the belt 41 is obtained, in the same manner as in the first manufacturing method, when the leveled ceramic slurry 13 is located at the press table 47, movement of the best 41 is once stopped, and an unplugged unfired honeycomb structure 12 is pressed in an arrow S3 direction with holding the honeycomb structure 12, for example, with an outer diameter chuck which is a part of a honeycomb structure conveying means in such a manner that an end portion of the unfired honeycomb structure 12 is pressed against the leveled ceramic slurry 13 to fill the ceramic slurry 13 into the cells 15a from the openings on one side of the cells 15a of the unfired honeycomb structure 12. The ceramic slurry 13 filled in the cells 15a is later dried and fired to form plugging members 3.

In the above plugging process, upon leveling the ceramic slurry 13, the plugging material supplier 53 is fixed, and the belt 41 is moved. However, the plugging material supplier 53 having the slit aperture 56 may be moved in parallel with the upper surface (plane) of the belt 41 with being brought into close contact with the upper surface (plane) with stopping the belt 41, or the plugging material supplier 53 may be moved with moving the belt 41.

In addition, in the above plugging process, upon filling the ceramic slurry 13 into the cells 15a from the openings on one side of the cells 15a, unplugged unfired honeycomb structure 12 is pressed in such a manner that an end face of the unfired honeycomb structure 12 is pressed against the leveled ceramic slurry 13. However, the press table 47 may be pressed from the bottom side to the top side of FIG. 5 so that the leveled ceramic slurry 13 on the belt 41 is pressed against an end face of the unfired honeycomb structure 12 with keeping an unplugged unfired honeycomb structure 12 stationary. Alternatively, the press table 47 may be pressed from the bottom side to the top side of FIG. 5 with pressing the unplugged unfired honeycomb structure 12 to press the leveled ceramic slurry 13 on the belt 41 against an end face of the unplugged unfired honeycomb structure 12.

After the plugging process on one end face 17a side is completed, the ceramic slurry 13 is dried. Then, in the other end face of the unfired honeycomb structure 12, ceramic slurry is filled into the open ends on the other side of the remaining cells 15b in the same manner. The following drying and firing gives a plugged honeycomb structure 1.

Next, in a method for manufacturing a plugged honeycomb structure of the present invention, there will be described a method where a plugging material is supplied with applying vibrations to the plugging material, the plugging material is leveled on a plane, and the plugging material is filled in cells from openings on one side of the cells of the honeycomb structure with applying vibrations to the leveled plugging material. Incidentally, though the following description is given for the second manufacturing method of a plugged honeycomb structure of the present invention, supplying a plugging material with applying vibrations to a plugging material and filling a plugging material in cells with applying vibrations to a leveled plugging material is applicable to the first manufacturing method of a plugged honeycomb structure of the present invention.

FIG. 10 is a view showing a plugging process and a view showing a state of filling the plugging material into cells of the unfired honeycomb structure 12 from a side (side where a peripheral face can be seen) of the unfired honeycomb structure 12. The embodiment shown in FIG. 10 employs a loop system belt conveyer where a belt 41 moves toward the arrow SI direction by the rotation of the roller 102 is used. The upper surface of the belt 41 of the belt conveyer is constituted as a plane where ceramic slurry 13 functioning as the plugging material is supplied. On the upper surface of the belt 41 is disposed a plugging material supplier 63 constituted by a gate 63a and a container 63b having a vibrator 94 mounted thereto. The plugging material supplier 63 has a slit aperture capable of changing the size of the opening by the gate 63a. An unfired honeycomb structure 12 to be plugged is disposed in a position facing the press table 107 via the belt 41. To the press table 107 supported by means of a spring 95 is attached a vibrator 93, and the press table 107 is disposed so as to be in contact with the belt 41.

By discharging a certain amount of ceramic slurry 13 as a plugging material per hour from the slit aperture of the plugging material supplier 63 on an upper surface (plane) of the belt 41 moving at a certain rate with applying vibrations of, for example, 250 Hz by the vibrator 94, the ceramic slurry 13 can be supplied on the upper surface of the belt 41 in a leveled state. The ceramic slurry 13 has a lowered viscosity by the vibrations, and the viscosity is preferable for leveling (preferable to keep a certain thickness).

After the ceramic slurry 13 leveled on the belt 41 is obtained, when the leveled ceramic slurry 13 is located at the press table 107, movement of the belt 41 is once stopped, and an unplugged unfired honeycomb structure 12 is pressed in an arrow S3 direction with holding the honeycomb structure 12, for example, with an outer diameter chuck which is a part of a honeycomb structure conveying means in such a manner that an end portion having a mask 19 disposed thereon of the unfired honeycomb structure 12 is pressed against the leveled ceramic slurry 13 with applying vibrations to the leveled ceramic slurry 13 by the vibrator 93 via the press table 107 and the belt 41 to fill the ceramic slurry 13 into the cells from the openings on one side of cells of the unfired honeycomb structure 12. The ceramic slurry 13 filled is later dried and fired to form plugging members 3.

The ceramic slurry 13 may move toward the outer (periphery) side of the honeycomb structure 12 if an end face of the honeycomb structure 12 is just pressed against the leveled ceramic slurry 13, which may cause uneven thickness of plugging members. However, if the honeycomb end face is pressed at a faint speed with applying vibrations to the ceramic slurry 13 after the honeycomb end face is brought in contact with the slurry, the ceramic slurry 13 goes into cells automatically by the vibrations. Therefore, the ceramic slurry 13 hardly moves toward the outer (peripheral) side, and thickness of the plugged members becomes uniform.

Next, in a method for manufacturing a plugged honeycomb structure of the present invention, a description will be given regarding a method for filling the plugging material in cells from openings on one side of cells with surrounding an end face of an unplugged honeycomb structure with a cylindrical jig by covering an outer periphery on the end face side of an unplugged honeycomb structure with the cylindrical jig. Though the following description is for the second manufacturing method of a plugged honeycomb structure of the present invention, it can also be applied to the first manufacturing method of a plugged honeycomb structure of the present invention.

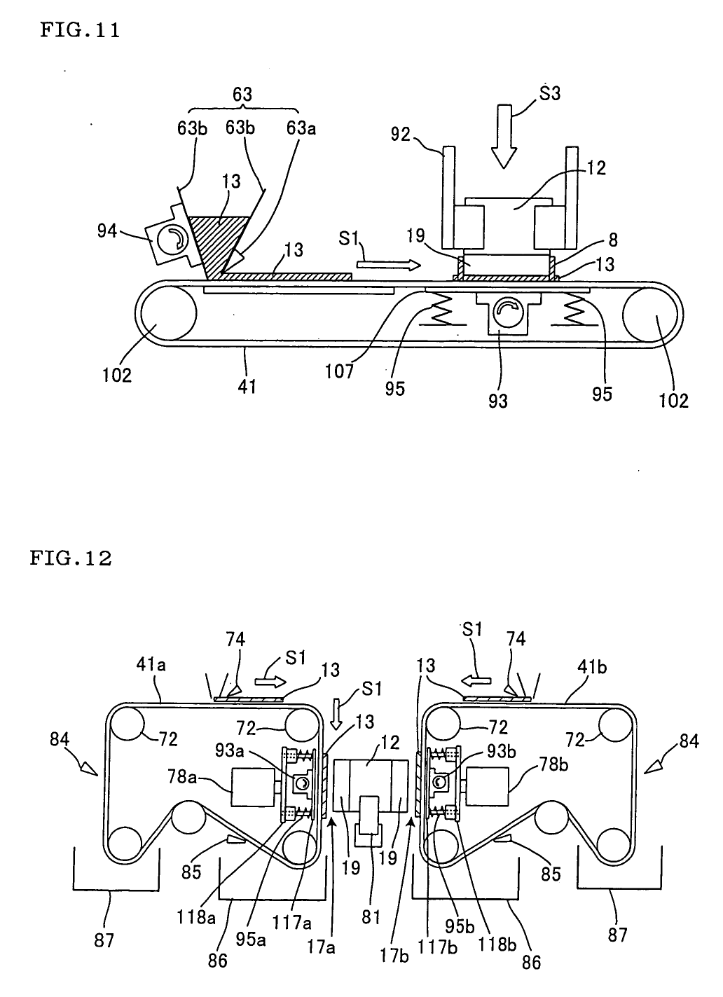

FIG. 11 is a view showing a plugging process and a view corresponding to FIG. 10 described above. The plugging process shown in FIG. 11 is different from that in FIG. 10 in that a cylindrical jig 8 is used upon filling the plugging material. The state of surrounding an end face of an unplugged honeycomb structure by the cylindrical jig is specially shown in FIG. 14. In the plugging process shown in FIG. 11, as shown in FIG. 14, an outer periphery on an end face side of an unplugged honeycomb structure 12 is covered with a cylindrical jig 8, and the tip end of the cylindrical jig 8 is allowed to protrude from the end face of the honeycomb structure 12 in advance (state shown in FIG. 14), and the unplugged unfired honeycomb structure 12 is pressed in the arrow S3 direction with allowing the cylindrical jig 8 to slide (upward in FIG. 14) so that the tip end of the cylindrical jig 8 may meet the end face of the honeycomb structure 12 to press the end face having a mask 19 disposed thereon of the unfired honeycomb structure 12 against the leveled ceramic slurry 13.

Since an end face of the unplugged honeycomb structure 12 is surrounded by the cylindrical jig 8, even if the end face of the honeycomb structure 12 is pressed against the leveled ceramic slurry 13, the ceramic slurry 13 cannot move outside (in the periphery of) the structure (shut off), and thickness of the plugging members becomes uniform.

The first manufacturing method and the second manufacturing method of a plugged honeycomb structure of the present invention has been described with an embodiment for each method. Next, an embodiment of a device for manufacturing a plugged honeycomb structure of the present invention will hereinbelow be described, and another embodiment of the first manufacturing method of the present invention using the device will be described. However, a device for manufacturing a plugged honeycomb structure of the present invention can also be used upon carrying out the second manufacturing method of the present invention, where a plugging process is different from that of the first manufacturing method.

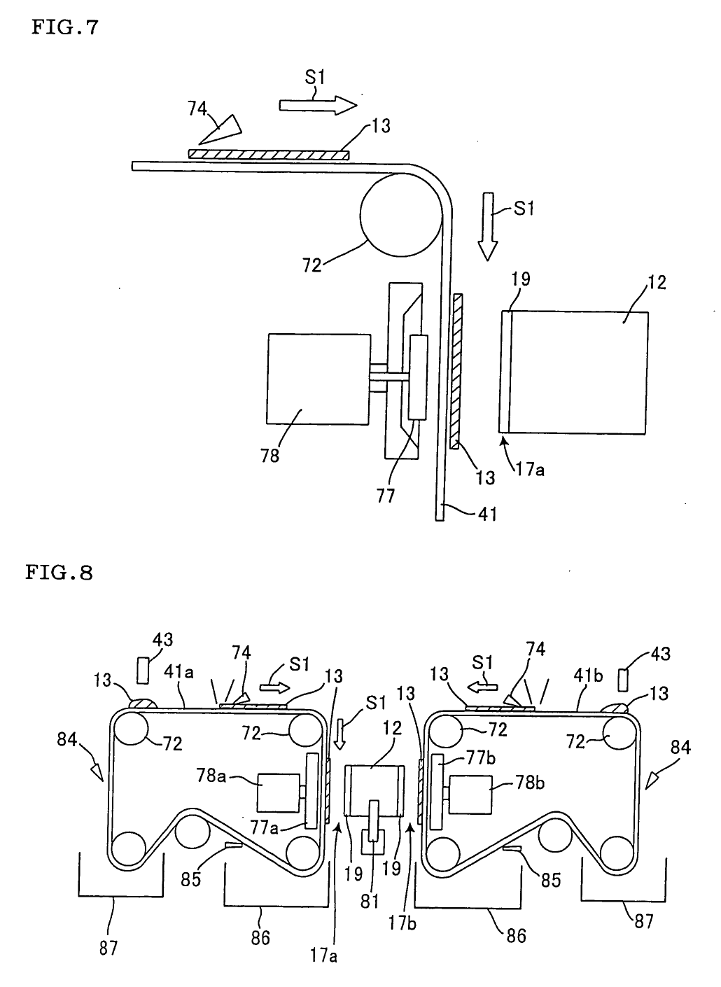

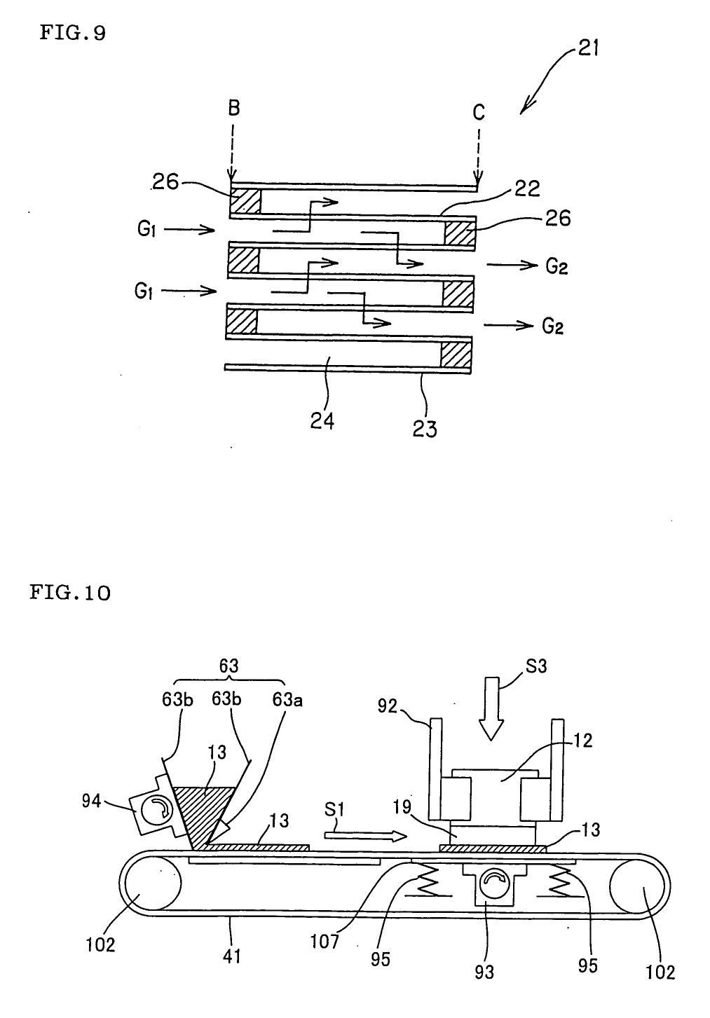

FIG. 7 is a side view showing an embodiment of a device for manufacturing a plugged honeycomb structure of the present invention. The device for manufacturing a plugged honeycomb structure shown in FIG. 7 is provided with a belt conveyer where a belt 41 having a plane is provided with a portion which horizontally moves and a portion which vertically moves, a plugging material supplier for supplying a plugging material to from plugging members on the plane of the belt 41, a leveling means for leveling the supplied plugging material on a portion where the belt 41 horizontally moves, a honeycomb structure fixing means for disposing and fixing a honeycomb structure 12 in such a manner that an end face 17a on one side where open ends of cells of the cylindrical honeycomb structure 12 are shown faces the plane of the belt 41 in a portion where the belt vertically moves, and a pressing means for pressing the leveled plugging member in a portion where the belt 41 vertically moves from the side opposite to the plane of the belt 41 where the plugging material is supplied to fill the plugging material into cells on the end face 17a on one side of the fixed honeycomb structure 12. In the belt conveyer, the belt 41 moves in the arrow S1 direction by the rotation of the roller 72. The plugged material is of ceramic slurry 13. The upper surface of the belt 41 of the belt conveyer is constituted as a plane where the ceramic slurry 13 as the plugging material is supplied. The plugging material supplier is not illustrated in FIG. 7. The leveling means is a means where the plugging material is supplied on the plane of the belt 41, and, by using a blade 74 having a straight-line side (leveling member), the blade 74 is moved so that the side of the blade 74 is in parallel with the plane. The pressing means is constituted by a press table 77 and a cylinder 78 as the driving source of the press table 77. Though a honeycomb structure fixing means is not illustrated in FIG. 7, for example, a means where a honeycomb structure is held and fixed with a receiving table and a retainer held from above can be employed.

FIG. 7 is also a view showing a plugging process in another embodiment of the first manufacturing method of the present invention. In FIG. 7, a state of filling the plugging material into cells of the unfired honeycomb structure 12 is shown from a side (side where a peripheral face can be seen) of the unfired honeycomb structure 12. The embodiment of the first manufacturing method of the present invention shown in FIG. 7 is different from the aforementioned embodiment shown in FIG. 4 in that plugging is performed with horizontally laying the unfired honeycomb structure 12. In addition, the embodiment shown in FIG. 7 is different from the embodiment shown in FIG. 4 in that, upon filling the ceramic slurry 13 into cells from openings on one side of the cells of the unfired honeycomb structure 12, the press table 77 is pressed from the left side to the right side (in the arrow S6 direction) of FIG. 7 to press the leveled ceramic slurry 13 on the belt 41 against an end face of the unplugged unfired honeycomb structure 12 with keeping the unplugged unfired honeycomb structure 12 stationary. The others are the same as in the embodiment shown in FIG. 4. To be concrete, the plugging material is filled in the cells of the honeycomb structure 12 in the following manner. First, the unfired honeycomb structure 12 where plugging is applied is disposed and fixed in a position facing the press table 77 via the belt 41. One the other hand, the ceramic slurry 13 is supplied on the upper surface (plane) of the belt 41 and leveled with the blade 74. After the ceramic slurry 13 is leveled on the upper surface of the belt 41, when the leveled ceramic slurry 13 is located at the press table 77, movement of the best 41 is once stopped, and the press table 77 is pressed by the driving force of the cylinder 78 with keeping the unplugged unfired honeycomb structure 12 fixed and stationary so that the leveled ceramic slurry 13 on the belt 41 is pressed against an end face of the unplugged unfired honeycomb structure 12 to fill the ceramic slurry 13 into the cells from the openings on one side of cells of the unfired honeycomb structure 12.

FIG. 8 is a side view showing another embodiment of a device for manufacturing a plugged honeycomb structure of the present invention. In the embodiment shown in FIG. 8, one more set of a belt conveyer, a plugging material supplier, a leveling means, and a pressing means are added so as to have two sets. The belt conveyers have a loop system. In each of the belt conveyers, each of the belts 41a and 41b moves in the arrow S1 direction by the rotation of five rollers 72. Each set on each of the both sides of the unfired honeycomb structure 12 is provided with a press table 77a and a cylinder 78a or a press table 77b and a cylinder 78b. The unfired honeycomb structure 12 where plugging is performed is disposed in a position facing the press tables 77a and 77b via the belts 41a and 41b. The upper surface of each of the belts 41a and 41b of the belt conveyers is constituted as a plane where ceramic slurry 13 as a plugging material is supplied, and the ceramic slurry 13 as a plugging material is supplied on the upper surface (plane) of each of the belts 41a and 41b from a nozzle 43 of the plugging material supplier (which is not illustrated) of each set. In each set, the slurry is leveled by a blade 74 as a leveling member. Incidentally, a walking beam 81 with a V receiver is a part of a honeycomb structure conveying means.

FIG. 8 is also a view showing a plugging process in still another embodiment of the first manufacturing method of the present invention. FIG. 8 shows a state of conducting the aforementioned embodiment shown in FIG. 7, i.e., the embodiment where plugging is conducted with laying the unfired honeycomb structure 12 horizontally on both the end faces of the unfired honeycomb structure 12 from a side (side where a peripheral face can be seen) of the unfired honeycomb structure 12. To be concrete, the plugging material is filled into the cells simultaneously in both the end faces of the honeycomb structure 12 as described below. After the ceramic slurry 13 is leveled on the upper surface of each of the belts 41a and 41b in each set of the belt conveyer, when the leveled ceramic slurry 13 is located at the press tables 77a and 77b, movement of the belts 41a and 41b is once stopped, and the press table 77a is pressed by the driving force of the left side cylinder 78a in FIG. 8 against the unplugged unfired honeycomb structure 12 conveyed by the walking beam 81 with a V receiver and fixed by the receiving table which is not illustrated and a retainer held from above so that the leveled ceramic slurry 13 on the belt 41a is pressed against an end face 17a on one side of the unplugged unfired honeycomb structure 12 to fill the ceramic slurry 13 into cells from the openings of the cells on an end face 17a side of the unfired honeycomb structure 12. In the same manner as this operation, the press table 77b is pressed by the driving force of the right side cylinder 78b in FIG. 8 so that the leveled ceramic slurry 13 on the belt 41b is pressed against an end face 17b on one side of the unplugged unfired honeycomb structure 12 to fill the ceramic slurry 13 into cells from the openings of the cells on an end face 17b side of the unfired honeycomb structure 12. By the above plugging process, the plugging material (ceramic slurry 13) can simultaneously be filled into cells in both the end faces of an unfired honeycomb structure.

Incidentally, in the embodiment shown in FIG. 8, since a loop-system belt conveyer is used, the ceramic slurry 13 is removed from the belts 41a and 41b by blades 85 as plugging material removing members in both the sets. Further, after performing washing with water and before the ceramic slurry 13 is newly supplied from the nozzle 43, washing and draining of the belts 41a and 41b are performed with an air knife 84. A drain generated by the washing with water is stored in a drain vessel 87. The ceramic slurry 13 removed by the blade 85 is stored in a collection box 86 and recycled as the plugging material.

FIG. 12 is a side view showing an embodiment wherein the embodiment shown in FIG. 8 is provided with a vibration applying means for applying vibrations to the plugging material supplied on a plane of the belt. The vibration applying means is provided in a portion where the belts 41a and 41b of the belt conveyers vertically move. Springs 95a and 95b, and supporting tables 118a and 118b are disposed between cylinders 78a and 78b, and the press tables 117a and 117b, respectively. According to this embodiment, the leveled ceramic slurry 13 can be vibrated by the vibrators 93a and 93b via the press tables 117a and 117b, and the belts 41a and 41b, and thereby the ceramic slurry 13 can be filled in the cells of the unfired honeycomb structure 12 with vibrating the ceramic slurry 13. By vibrating the ceramic slurry 13, the ceramic slurry 13 goes into cells automatically by the vibrations. Therefore, slurry having high viscosity, which hardly causes a shrink dent and which has high shape-retainability after leveling, can be employed, and quality of a resultant plugging member is enhanced.

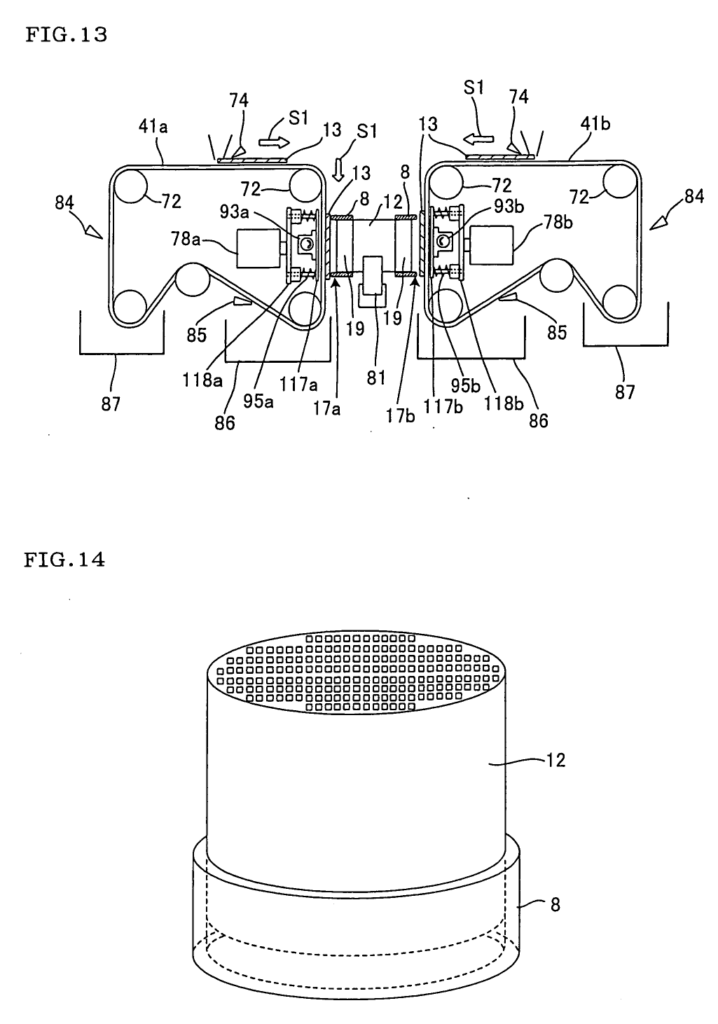

FIG. 13 is a view showing a state where, in the embodiment shown in FIG. 12, an outer periphery on an end face side of an unplugged honeycomb structure 12 is covered with a cylindrical jig 8 (see FIG. 14) to fill the plugging material in cells with covering the end face of the unplugged honeycomb structure 12 with a cylindrical jig 8. Since an end face of the unplugged honeycomb structure 12 is surrounded by the cylindrical jig 8, even if the end face of the honeycomb structure 12 is pressed against the leveled ceramic slurry 13, the ceramic slurry 13 cannot move outside (in the periphery of) the structure, and thickness of the plugging members becomes uniform.

### EXAMPLE

The present invention will hereinbelow be described concretely with referring to examples. However, the present invention is by no means limited to the following examples.

### Example 1

A forming raw material prepared by adding water and a binder to a cordierite-forming raw material containing talc, kaolin, and alumina as main raw materials, and subjected to dispersion mixing and kneading was extruded into a cylindrical shape by a kneader and then subjected to extrusion forming by an extrusion forming machine to obtain a honeycomb formed body. After the honeycomb formed body was dried, it was cut to have a predetermined length to obtain a honeycomb dried body.

Next, a plurality of cells (cell group) on both the end faces of the obtained honeycomb dried body were alternately plugged in the plugging process based on the first manufacturing method of a plugged honeycomb structure of the present invention, followed by firing to obtain a honeycomb fired body. After grinding and removing the outer peripheral wall and the partition walls pertinent to about 1 to 3 cells from the outermost periphery of the honeycomb fired body, a ceramic coat material was applied on the outer periphery and dried at a low temperature of 200° C. or less in order to remove water. Thus, an outer peripheral wall was newly formed on the honeycomb fired body to obtain a cordierite honeycomb structure.

Incidentally, a ceramic coat material may be applied after removing the (original) outer peripheral wall of the honeycomb fired body and firing. Alternatively, firing may be performed after applying a ceramic coat material. Though it is general that, after a ceramic coat material is applied, drying at low temperature is performed, high temperature thermal treatment may be performed in order to make the ceramic coat material firm.

By the above method, there was manufactured a honeycomb structure having, for example, a square cross-section of the cells, a partition wall thickness of 0.3 mm, a standard cell density of 300 cpsi (46.5 cells/cm²), a cylindrical outer shape (outer diameter: 191 mm, length: 203 mm) after a new outer peripheral wall was formed, and a depth of plugging of 10 mm. In a conventional plugging method (plugging process), an accuracy of depth of plugging was 10±5 mm. However, by the first manufacturing method of a plugged honeycomb structure of the present invention, an accuracy of 10±3 mm could be obtained.

### Examples 2 and 3

By a means similar to that of Example 1, there was manufactured a honeycomb structure having a square cross-section of the cells, a partition wall thickness of 0.3 mm, a standard cell density of 200 cpsi (31 cells/cm²), a cylindrical outer shape (outer diameter: 229 mm, length: 305 mm) after coating an outer periphery, and a depth of plugging of 10 mm (Example 2). In addition, by a means similar to that of Example 1, there was manufactured a honeycomb structure having a square cross-section of the cells, a partition wall thickness of 0.3 mm, a standard cell density of 200 cpsi (31 cells/cm²), a cylindrical outer shape (outer diameter: 460 mm, length: 500 mm) after coating an outer periphery, and a depth of plugging of 10 mm (Example 3). An accuracy of depth of plugging in Examples 2 and 3 was 10±3 mm, which was the same as in Example 1. These honeycomb structures had a porosity of 45 to 70%, an average pore size of 5 to 30 μm, an average thermal expansion coefficient of about 0.1 to 1.0×10⁻⁶/° C. in the axial direction at 40 to 800° C.

### Examples 4, 5, and 6

By a means similar to that of Example 1, there was manufactured a honeycomb structure having a combination of octagonal and square cross-sections of the cells, a partition wall thickness of 0.41 mm, a standard cell density of 300 cpsi (46.5 cells/cm²), a cylindrical outer shape (outer diameter: 191 mm, length: 203 mm) after coating an outer periphery, and a depth of plugging of 10 mm (Example 4). In addition, by a means similar to that of Example 1, there was manufactured a honeycomb structure having a combination of octagonal and square cross-sections of the cells, a partition wall thickness of 0.41 mm, a standard cell density of 300 cpsi (46.5 cells/cm²), a cylindrical outer shape (outer diameter: 229 mm, length: 305 mm) after coating an outer periphery, and a depth of plugging of 10 mm (Example 5). Further, by a means similar to that of Example 1, there was manufactured a honeycomb structure having a combination of octagonal and square cross-sections of the cells, a partition wall thickness of 0.41 mm, a standard cell density of 300 cpsi (46.5 cells/cm²), a cylindrical outer shape (outer diameter: 460 mm, length: 500 mm) after coating an outer periphery, and a depth of plugging of 10 mm (Example 6). An accuracy of depth of plugging in Examples 4, 5, and 6 was 10±3 mm, which was the same as in Example 1.

### Example 7

There was manufactured a honeycomb structure having a cylindrical outer shape (outer diameter: 144 mm, length: 152 mm) and a depth of plugging of 3 mm by the same means as that of Example 1 except that it was manufactured by unitary forming without applying machining on the outer periphery. In a conventional plugging method (plugging process), an accuracy of depth of plugging was 3±2 mm. However, by the first manufacturing method of a plugged honeycomb structure of the present invention, an accuracy of 3±1 mm could be obtained. By this, a depth of plugging can be made so shallow as 1 to 2 mm. In the outer peripheral portion of the honeycomb structure, cells were brought in contact With the outer wall to form incomplete cells, and plugging of incomplete cells was also performed alternately. In the case of plugging in a vertical state, accuracy of depth of plugging grows worth than that in the case of plugging in a horizontal state in a conventional method. However, according to (a plugging process based on) the first manufacturing method of a plugged honeycomb structure of the present invention, the accuracy does not grow worth even in a vertical state.

A method for manufacturing a plugged honeycomb structure of the present invention is suitably used as a means for manufacturing a plugged honeycomb structure used as a carrier for a catalyst device or as a filter such as a DPF.

What is claimed is:

1. A method for manufacturing a plugged honeycomb structure provided with a cylindrical honeycomb structure having a plurality of cells functioning as fluid passages and partitioned by porous partition walls and plugging members for plugging open ends on one side of the cells,
wherein the method has a process of forming the plugging members on open ends on one side of the cells, the process comprising the steps of:
preparing an unplugged honeycomb structure,
supplying a plugging material on a plane and leveling the plugging material on the plane by moving a leveling member having a straight-line side or by moving the plane to allow the leveling member to pass in such a manner that a side of the leveling member is in parallel with the plane, and
filling the plugging material into cells from openings on one side of the cells by pressing an end face of the unplugged honeycomb structure against the leveled plugging material on the plane or by pressing the leveled plugging material against the end face of the unplugged honeycomb structure on the plane.

2. A method for manufacturing a plugged honeycomb structure according to claim 1, wherein vibrations are applied to the plugging material when the plugging material is supplied on the plane.

3. A method for manufacturing a plugged honeycomb structure according to claim 1, wherein vibrations are applied to the plugging material leveled on the plane when the plugging material is filled into the cells from the openings on one side of the cells.

4. A method for manufacturing a plugged honeycomb structure according to claim 1, wherein an outer periphery on the end face side of the unplugged honeycomb structure is covered with a cylindrical jig to surround the end face of the unplugged honeycomb structure by the cylindrical jig when the plugging material is filled into the cells from the openings on one side of the cells.

5. A method for manufacturing a plugged honeycomb structure according to claim 1, wherein the plane is horizontal when the plugging material is leveled, and the plane is vertical when the end face of the unplugged honeycomb structure is pressed against the leveled plugging material or when the leveled plugging material is pressed against the end face of the unplugged honeycomb structure.

6. A method for manufacturing a plugged honeycomb structure according to claim 5, wherein the cylindrical unplugged honeycomb structure is maintained in such a matter that the end faces face horizontal directions, the plugging material is leveled on the planes on both the end face sides of the honeycomb structure, pressing the plugging material leveled on the planes against both the end faces of the unplugged honeycomb structure at the same time.

7. A method for manufacturing a plugged honeycomb structure according to claim 1, wherein the plugging material is of ceramic slurry containing a pore former.

8. A method for manufacturing a plugged honeycomb structure according to claim 7, wherein the ceramic slurry has a viscosity of 50 to 1500 dPa·s.

9. A method for manufacturing a plugged honeycomb structure provided with a cylindrical honeycomb structure having a plurality of cells functioning as fluid passages and partitioned by porous partition walls and plugging members for plugging open ends on one side of the cells,
wherein the method has a process of forming the plugging members on open ends on one side of the cells, the process comprising the steps of:
preparing an unplugged honeycomb structure,
disposing a plugging material supplier having a slit aperture on a plane in parallel with the plane and supplying a plugging material on a plane from the slit aperture of the plugging material supplier with moving the plugging material supplier or with moving the plane to level the plugging material on the plane, and
filling the plugging material into the cells from openings on one side of the cells by pressing an end face of the unplugged honeycomb structure against the leveled plugging material on the plane or by pressing the leveled plugging material against the end face of the unplugged honeycomb structure on the plane.

10. A method for manufacturing a plugged honeycomb structure according to claim 9, wherein vibrations are applied to the plugging material when the plugging material is supplied on the plane.

11. A method for manufacturing a plugged honeycomb structure according to claim 9, wherein vibrations are applied to the plugging material leveled on the plane when the plugging material is filled into the cells from the openings on one side of the cells.

12. A method for manufacturing a plugged honeycomb structure according to claim 9, wherein an outer periphery on the end face side of the unplugged honeycomb structure is covered with a cylindrical jig to surround the end face of the unplugged honeycomb structure by the cylindrical jig.

13. A method for manufacturing a plugged honeycomb structure according to claim 9, wherein the plane is horizontal when the plugging material is leveled, and the plane is vertical when the end face of the unplugged honeycomb structure is pressed against the leveled plugging material or when the leveled plugging material is pressed against the end face of the unplugged honeycomb structure.

14. A method for manufacturing a plugged honeycomb structure according to claim 13, wherein the cylindrical unplugged honeycomb structure is kept in such a matter that the end faces face horizontal directions, the plugging material is leveled on the planes on both the end face sides of the honeycomb structure, pressing the plugging material leveled on the planes against both the end faces of the unplugged honeycomb structure at the same time.

15. A method for manufacturing a plugged honeycomb structure according to claim 9, wherein the plugging material is of ceramic slurry containing a pore former.

16. A method for manufacturing a plugged honeycomb structure according to claim 15, wherein the ceramic slurry has a viscosity of 50 to 1500 dPa·s.

17. A device for manufacturing a plugged honeycomb structure by plugging open end on one side of a plurality of cells functioning as fluid passages and partitioned by porous partition walls of a cylindrical honeycomb structure with plugging members, the device comprising:
a belt conveyer provided with a portion where a belt having a plane horizontally moves and a portion where the belt vertically moves,
a plugging material supplier for supplying a plugging material to function as the plugging member on the plane of the belt,
a leveling means for leveling the plugging material supplied on the plane on a portion where the belt horizontally moves,
a honeycomb structure fixing means for disposing and fixing a honeycomb structure in such a manner that an end face on one side where open ends of the cells of the cylindrical honeycomb structure are shown faces the plane of the belt in a portion where the belt vertically moves, and
a pressing means for pressing the leveled plugging member in a portion where the belt vertically moves from the side opposite to the plane of the belt where the plugging material is supplied to fill the plugging material into the cells on the end face on one side of the fixed honeycomb structure.

18. A device for manufacturing a plugged honeycomb structure according to claim 17, having a vibration applying means for applying vibrations to the plugging material supplied on a plane of a portion where the belt of the belt conveyer vertically moves.

19. A device for manufacturing a plugged honeycomb structure according to claim 17, wherein the plugging material supplier is provided with a vibration applying means for applying vibrations to the plugging material.

20. A device for manufacturing a plugged honeycomb structure according to claim 17, wherein the plugging material can be filled into the cells simultaneously from both the one end face side and the other end face side of the fixed honeycomb structure by
providing the device with a second set of the belt conveyer, the plugging material supplier, the leveling means, and the pressing means,
disposing the belt conveyer of the second set in such a manner that the other end face where open ends of cells of the fixed cylindrical honeycomb structure faces a plane of the belt on a portion where the belt of the belt conveyer of the second set vertically moves, and
pressing the plugging material supplied by the plugging material supplier of the second set on a plane of the belt of the belt conveyer of the second set and leveled by the leveling means of the second set in a portion where the belt of the belt conveyer of the second set vertically moves from the side opposite to the plane of the belt where the plugging material is supplied by the pressing means of the second set simultaneously with an original pressing means.

21. A device for manufacturing a plugged honeycomb structure according to claim 17, wherein the belt of the belt conveyer has a loop system.
